(19) United States
(12) Patent Application Publication
(10) Pub. No.: US 2024/0311356 A1
(43) Pub. Date: Sep. 19, 2024

(54) Workload-Driven Index Selections

(71) Applicant: Google LLC, Mountain View, CA (US)

(72) Inventors: Haoyu Huang, Fremont, CA (US); Vincent Zhuang, Mountain View, CA (US); Sam Idicula, Santa Clara, CA (US); Gaurav Jain, Mountain View, CA (US)

(73) Assignee: Google LLC, Mountain View, CA (US)

(21) Appl. No.: 18/183,925

(22) Filed: Mar. 14, 2023

(51) Int. Cl. G06F 16/22; G06F 16/2453; G06F 16/2455

(52) U.S. Cl. CPC G06F 16/221; G06F 16/24542; G06F 16/2455

(57) ABSTRACT

A method for workload-driven index selections includes receiving a request for a recommended index configuration. The method includes obtaining a plurality of queries executed at the database. The method also includes selecting a set of candidate indexes from the plurality of indexes. The method includes for each respective candidate index of the set of candidate indexes, determining, based on the plurality of queries, a respective workload cost for the respective candidate index. The method also includes selecting, based on the respective workload cost, a first candidate index from the set of candidate indexes for the recommended index configuration. The method includes selecting one or more additional candidate indexes from the set of candidate indexes for the recommended index configuration. The method includes determining that a size of the selected candidate indexes satisfies a size threshold and transmitting the recommended index configuration.

### TECHNICAL FIELD

This disclosure relates to workload-driven index selections.

### BACKGROUND

Big data is an increasingly popular and useful tool for data analytics. With advances in technology, such as cloud and parallel computing, the amount of data that can be stored in a big data database is constantly increasing. While the large size of big data can provide more valuable insights using analytics, there are a number of drawbacks that come along with the magnitude of data. For example, executing queries in a big data database can be a slow and resource intensive process. To expedite queries in big data, certain data (e.g., frequently used data) can be stored as an index to be accessed more quickly.

### SUMMARY

One aspect of the disclosure provides a computer-implemented method for workload-driven index selection. The computer-implemented method when executed by data processing hardware causes the data processing hardware to perform operations including receiving a request for a recommended index configuration, the recommended index configuration including a selection of a subset of a plurality of indexes of a database to be stored in a memory of the database. The operations further include obtaining a plurality of queries executed at the database. The operations include selecting, based on the plurality of queries, a set of candidate indexes from the plurality of indexes. The operations also include for each respective candidate index of the set of candidate indexes, determining, based on the plurality of queries, a respective workload cost for the respective candidate index, the respective workload cost representative of an amount of resources to execute the plurality of queries using the respective candidate index. Further, the operations include selecting, based on the respective workload cost, a first candidate index from the set of candidate indexes for the recommended index configuration. The operations include, based on selection of the first candidate index from the set of candidate indexes, selecting one or more additional candidate indexes from the set of candidate indexes for the recommended index configuration. The operations include determining that a size of the recommended index configuration satisfies a size threshold. The operations also include based on determining that the size of the recommended index configuration satisfies the threshold, transmitting the recommended index configuration.

Implementations of the disclosure may include one or more of the following optional features. In some implementations, each candidate index of the set of candidate indexes is a single column index. The plurality of queries may be associated with a query hash. In some implementations, selecting the one or more additional candidate indexes from the set of candidate indexes includes an iterative process that includes, for each respective candidate index of the set of candidate indexes not in the recommended index configuration, determining, based on the plurality of queries, a second respective workload cost for the respective candidate index, the second respective workload cost representative of an amount of resources to execute the plurality of queries using the respective candidate index and each index in the recommended index configuration. These implementations also include selecting, based on the second respective workload cost, a second candidate index from the set of candidate indexes for the subset of the plurality of indexes.

In some implementations the operations further include selecting one or more additional candidate indexes for the recommended index configuration until the recommended index configuration satisfies an improvement threshold. The database may be a cloud database. Further, the workload cost may be based on query stats of the plurality of queries. Here, the query stats may include one or more of a type of query, an extrusion time, a number of calls, or an order of queries. In some implementations, the operations further include obtaining a new plurality of queries and selecting, based on the new plurality of queries, a new recommended index configuration. A number of candidate indexes in the set of candidate indexes may be configurable by a user.

Another aspect of the disclosure provides a system for workload-driven index selection. The system includes data processing hardware and memory hardware in communication with the data processing hardware. The memory hardware stores instructions that when executed on the data processing hardware cause the data processing hardware to perform operations. The operations include receiving a request for a recommended index configuration, the recommended index configuration including a selection of a subset of a plurality of indexes of a database to be stored in a memory of the database. The operations further include obtaining a plurality of queries executed at the database. The operations include selecting, based on the plurality of queries, a set of candidate indexes from the plurality of indexes. The operations also include for each respective candidate index of the set of candidate indexes, determining, based on the plurality of queries, a respective workload cost for the respective candidate index, the respective workload cost representative of an amount of resources to execute the plurality of queries using the respective candidate index. Further, the operations include selecting, based on the respective workload cost, a first candidate index from the set of candidate indexes for the recommended index configuration. The operations include, based on selection of the first candidate index from the set of candidate indexes, selecting one or more additional candidate indexes from the set of candidate indexes for the recommended index configuration. The operations include determining that a size of the recommended index configuration satisfies a size threshold. The operations also include based on determining that the size of the recommended index configuration satisfies the threshold, transmitting the recommended index configuration

This aspect may include one or more of the following optional features. In some implementations, each candidate index of the set of candidate indexes is a single column index. The plurality of queries may be associated with a query hash. In some implementations, selecting the one or more additional candidate indexes from the set of candidate indexes includes an iterative process that includes, for each respective candidate index of the set of candidate indexes not in the recommended index configuration, determining, based on the plurality of queries, a second respective workload cost for the respective candidate index, the second respective workload cost representative of an amount of resources to execute the plurality of queries using the respective candidate index and each index in the recommended index configuration. These implementations also include selecting, based on the second respective workload cost, a second candidate index from the set of candidate indexes for the subset of the plurality of indexes.

In some implementations the operations further include selecting one or more additional candidate indexes for the recommended index configuration until the recommended index configuration satisfies an improvement threshold. The database may be a cloud database. Further, the workload cost may be based on query stats of the plurality of queries. Here, the query stats may include one or more of a type of query, an extrusion time, a number of calls, or an order of queries. In some implementations, the operations further include obtaining a new plurality of queries and selecting, based on the new plurality of queries, a new recommended index configuration. A number of candidate indexes in the set of candidate indexes may be configurable by a user

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for workload-driven index selection.

FIG. 2 illustrates a schematic diagram of an example data table having a plurality of indexes.

FIG. 3 illustrates a schematic view of an example iterative process for generating a recommended index configuration

FIG. 4 a flowchart of an example arrangement of operations for a method of workload-driven index selection.

FIG. 5 is a schematic view of an example computing device that may be used to implement the systems and methods described herein.

Like reference symbols in the various drawings indicate like elements.

### DETAILED DESCRIPTION

In big data, a data table can have thousands or millions of rows and columns. Querying such a large data table can take significant amounts of time as the system traverses each row and/or column of the data table to find relevant data for the query. To expedite queries and lower the overall workload of the system, frequently used data can be stored in as an index in a memory of the system. For example, a number of indexes (e.g., columns of a data table) can be stored in the memory for quick access when executing the query. However, due to the very large solution space, identifying the best set of indexes to store is a difficult problem to solve and is a significant pain point for database analysts who need to manage a large number of databases at cloud scale. Even with expert knowledge of a database's internals, it is challenging to continually update the set of indexes in the memory as the workload of the data base changes over time.

Implementations herein are directed toward systems and methods for workload-driven index selections. In some implementations, an index recommendation system stores historical queries in a database. Upon receiving a request or an indication for a recommended index configuration, an index module may select a set of candidate indexes based on the historical queries in the database (i.e., the indexes that are most relevant to the queries). The workload module may then implement an iterative process to select indexes from the set of candidate indexes for the recommended index configuration. In some implementations, the iterative process involves, at each iteration, determining a workload cost for each candidate index of the set of candidate indexes and then selecting the candidate index with the lowest workload cost for the recommended index configuration. The iterative process may continue until the recommended index configuration satisfies a predetermined threshold.

Providing workload-driven index selections in real-time leads to many benefits in executing queries in a big data system. For example, queries may execute nearly twice as fast when the recommended indexes are stored in the memory. Additionally, storing recommended indexes (e.g., an optimized set of) in the memory makes more efficient use of memory resources, allowing for similar execution times with a fraction of the indexes stored in the memory compared to traditional systems.

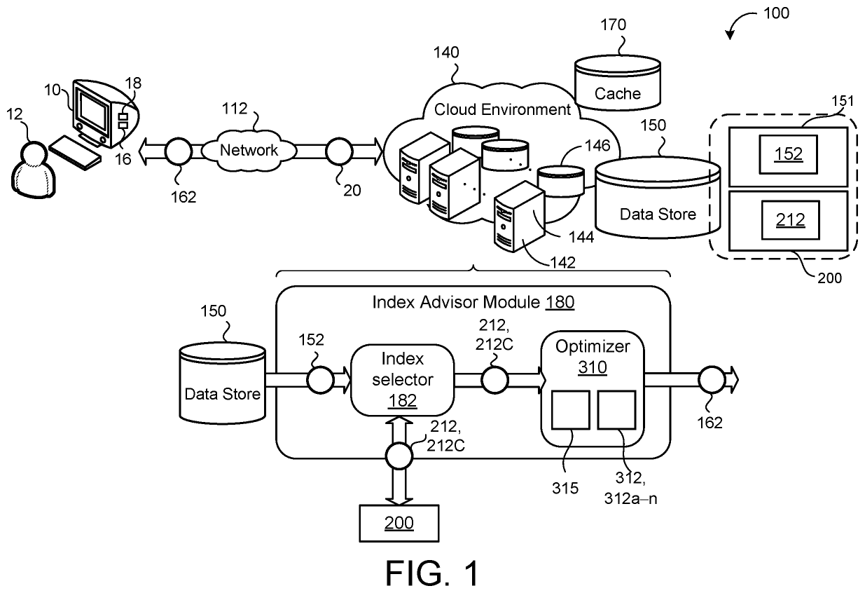

Referring to FIG. 1, in some implementations, an example workload-driven index selection system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware) and 170 (e.g., a memory cache). The remote system 140 may be configured to store a large amount of data for use in big data analytics. A data store 150 (i.e., a remote storage device) may be overlain on the storage resources 146 to allow scalable use of the storage resources 146 by one or more of the clients (e.g., the user device 10) or the computing resources 144. The data store 150 is configured to store a plurality of queries 152 associated with a query hash 151. That is, the each query 152 of the plurality of queries 152 may be identified using a unique query hash. Further, the data store 150 is configured to store a data table 200 including a plurality of indexes 212 (e.g., columns of the data table 200).

The remote system 140 is configured to obtain an indication or a request 20 for a recommended index configuration 162 from, for example, a user device 10 associated with a respective user 12 via the network 112. The request 20 requests that the recommended index configuration 162 include a selection of a subset of the plurality of indexes 212 stored at the database 150. Here, the recommended index configuration 162 represents the indexes 212 that are recommended to be stored at the database 150 for optimal performance of queries 152 of the database 150. Alternatively, the recommended index configuration 162 indicates the indexes 212 that should be stored in the memory cache 170. When the remote system 140 receives queries for data that is related to indexes 212 stored at the database 150, the remote system 140 may return the queried data by the indexes 212 instead of the relatively slower data table 200. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

The remote system 140 executes an index advisor module 180 for determining the recommended index configuration 162. The index advisor module 180 is configured to receive the request 20 (e.g., from the user 12 via the user device 10, remote servers, or other modules of the remote system 140). The index advisor module 180, in some implementations, includes an index selector 182 that, in response to the request 20, selects a set of candidate indexes 212, 212C from the data table 200. A quantity or number of indexes 212 in the set of candidate indexes 212C may be based on a predetermined number (e.g., a static number, based on a size or a number of columns of the data table 200, etc.). Alternatively, the number of indexes 212 in the set of candidate indexes 212C is configured by a user 12 (i.e., the user 12 that generated the request 20). In some implementations, the index selector 182 selects the set of candidate indexes 212C based on the plurality of queries 152. The queries 152 may include query stats that provide insights into the workload of the system including query execution time, a type of query, an extrusion time, an order of queries, a number of calls, a data type, etc. In particular, index selector 182 may analyze the plurality of queries 152 to determine which indexes 212 are most relevant to the queries 152. The queries 152 may be historical queries 152 that queried the data table 200 prior to obtaining the request 20, queries 152 that query the data table subsequent to obtaining the request 20, or any combination of the two.

The index selector 182 transmits the set of candidate indexes 212C to an optimizer 310. In some implementations, the optimizer 310 implements an iterative process to evaluate the set of candidate indexes 212C to determine the recommended index configuration 162. For example, the optimizer 310, at a first iteration, determines a workload cost 315 for each candidate index 212C in the set of candidate indexes 212C. In some implementations the workload cost 315 is based on the plurality of queries 152. That is, the optimizer 310 may, for each respective candidate index 212C, determine or estimate or predict the workload cost 315 of the queries 152 if the queries 152 were executed against the data table with the respective candidate index 212C stored at the database 150. In some implementations, the optimizer 310 determines the workload cost 315 without actually performing the query 152. For example, the optimizer 310 implements a query planner to simulate/model queries 152 using known techniques to determine the respective workload costs 315. The query planner may determine and/or estimate the workload cost 315 based on the plurality of queries 152 and/or data related to the plurality of queries 152 such as query stats (e.g., execution time, extrusion time, number of calls) and/or metadata.

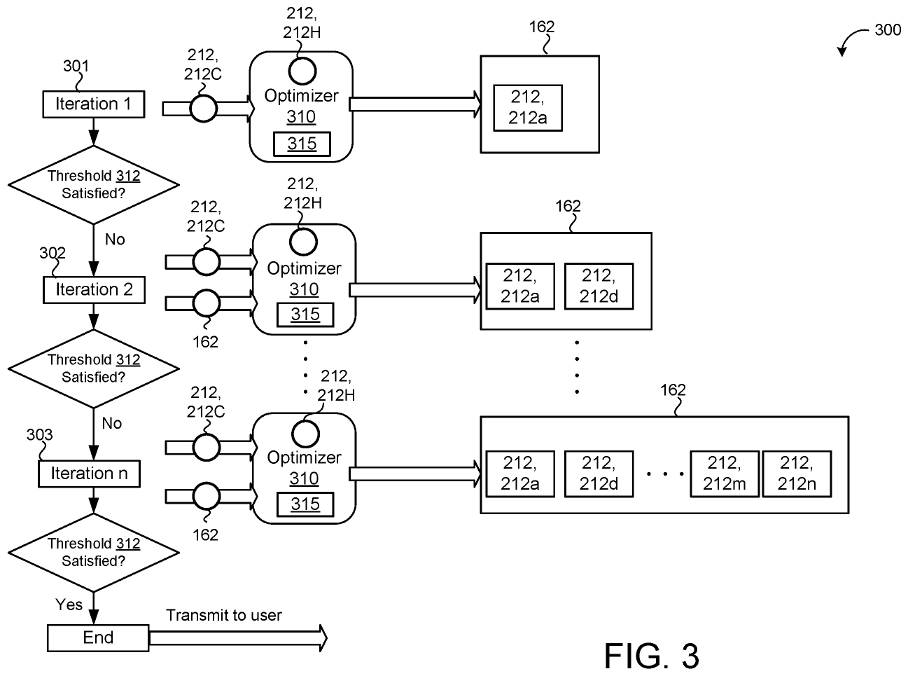

The optimizer then selects a first index 212, 212a (FIG. 3) from the set of candidate indexes 212C to include within the recommended index configuration 162 based on the workload cost 315. In some implementations, the optimizer 310 selects the candidate index 212C with the lowest workload cost 315 from the set of candidate indexes 212C for the recommended index configuration 162 (i.e., the candidate index 212C that increases the performance of the database the most when executing the queries 152). The optimizer 310, after selecting a candidate index 212C for the recommended index configuration 162, may determine whether the recommended index configuration 162 satisfies a threshold 312 from a set of thresholds 312, 312a-n. The set of thresholds 312 may include any constraint related to the recommended index configuration 162. The thresholds 312 may be predetermined and/or user-configurable. For example, the thresholds 312 include a size threshold 312, 312a indicative of a maximum memory size for the recommended index configuration 162 (e.g., equal to or less than a size of an allotted memory space at the database 150). The thresholds 312 may include an index quantity threshold 312b indicative of a maximum number of indexes 212 to include within the recommended index configuration 162. As another example, the thresholds 312 include an improvement threshold 312c indicative of a minimum improvement in the workload cost 315 at each iteration (i.e., a threshold performance increase that additional indexes must satisfy to be included within the recommended index configuration 162) or a maximum quantity of iterations. Other thresholds 312 may be included. The optimizer 310 may be required to satisfy only one of the thresholds 312, all of the thresholds, or any number in between.

When the recommended index configuration 162 does not satisfy one or more of the thresholds 312, the optimizer 310 continues to a next iteration of the iterative process, as discussed in greater detail below (FIG. 3). For example, when a size of the recommended index configuration 162 is 50 MB (i.e., the indexes 212 selected for the recommended index configuration 162 require 50 MB of storage space) and the size threshold 312a is equal to 300 MB, then the optimizer 310 continues to the next iteration to add additional indexes 212 (i.e., because there is still additional space to add indexes 212). The optimizer 310 continues the iterative process (i.e., selecting and adding indexes 212 to the recommended index configuration 162) until the recommended index configuration 162 is complete. Once the recommended index configuration 162 is complete, the index advisor module 180 transmits the recommended index configuration 162 to the user device 10 which generated the initial request 20. In some implementations, the index advisor module 180 updates and/or maintains an index table to store the list of indexes 212 of the recommended index configuration 162 (as well as any indexes 212 stored in the database 150) along with information from the data table 200 (e.g., a column number of the data table 200, data stored in the index 212) related to the respective index 212.

The index advisor module 180 can generate new recommended index configurations 162 (i.e., after an initial recommended index configuration 162 is generated) as needed. For example, the index advisor module 180 can determine or generate a recommended index configuration 162 when a predetermined number of new or additional queries 152 have been associated with the query hash 151. Alternatively, the index advisor module 180 generates a recommended index configuration 162 upon receiving the request 20 from the user 12 via user device 10 or after a threshold period of time has passed. In some implementations, the index advisor module 180 generates a recommended index configuration 162 periodically accordingly to a schedule. In this manner, the database analyst (e.g., user 12) can continue to update the database 150 with the optimal index 212 configuration. In turn, the system 100 can operate with an optimal workload such that system resources are used efficiently and such that queries 152 can be executed faster.

The system of FIG. 1 is presented for illustrative purposes only and is not intended to be limiting. For example, although only a single example of each component is illustrated, the system 100 may include any number of components 10, 112, 140, 150, 170, and 180. Further, although some components are described as being located in a cloud computing environment 140, in some implementations, some or all of the components may be hosted locally on the user device 10. Further, in various implementations, some or all of the components 150 and 180, are hosted locally on user device 110, remotely (such as in the cloud computing environment 140), or some combination thereof.

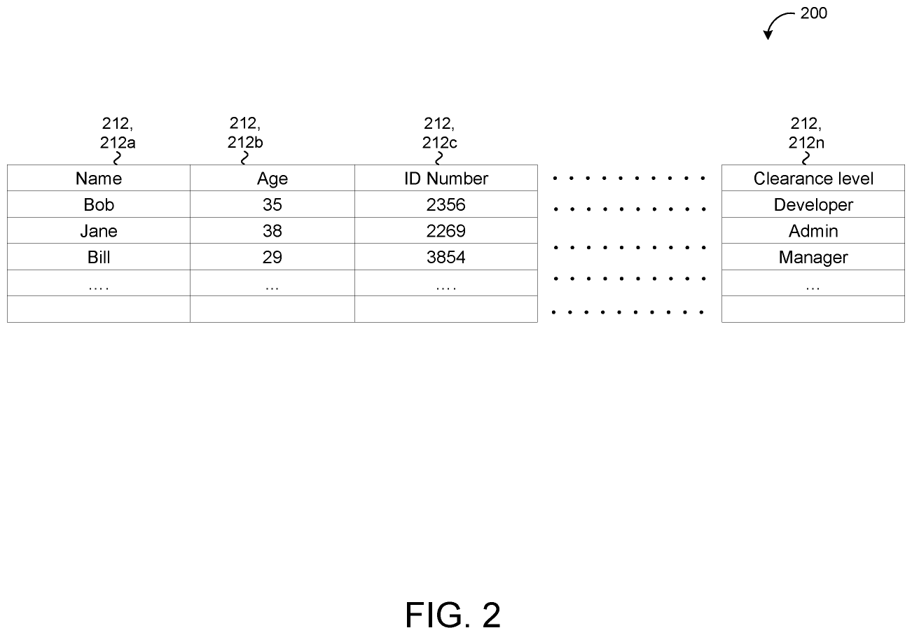

FIG. 2 illustrates a schematic diagram of an example data table 200 having a plurality of indexes 212a-n (i.e., columns). The data table 200 represents data stored in a database 150 (FIG. 1) for use in big data. In some implementations, each index 212 is a single column index 212 (i.e., a column of the data table) as illustrated in FIG. 2. Alternatively, an index 212 includes a pair or more of columns. In other implementations, each index 212 is one or more rows of the data table 200. The indexes 212 may be a combination of indexes as described above (e.g., a single column index 212, a pair of column index 212, or a row index 212). The above examples are not intended to be limiting. The data stored in database 150 can be in any appropriate form for performing queries in big data. Further, the indexes 212 can be in any appropriate form for storing a portion of data from the data table 200 in database 150 as indexes 212 for use in performing queries on the data table 200 on the database 150.

FIG. 3 illustrates a schematic view of an example iterative process 300 for generating a recommended index configuration 162. The iterative process 300 begins at a first iteration 301. At the first iteration 301, the optimizer 310 receives the set of candidate indexes 212C and determines a workload cost 315 for each index 212 in the set of candidate indexes 212C. In some implementations, the optimizer 310 generates a respective hypothetical index 212H for each candidate index 212C from the set of candidate indexes 212C to be used in determining the respective workload cost 315. The hypothetical index 212H is representative of the respective candidate index 212C such that the optimizer 310 can simulate execution of queries 152 to determine the workload cost 315. The respective workload cost 315 for each index 212 of the set of candidate indexes 212C may be based on the respective hypothetical index 212H, the queries 152, or the query stats for each respective query 152. The optimizer 310 evaluates how each query 152 would perform if each respective index 212 was stored in the database 150 of the system. In some implementations, the optimizer 310 implements a query planner that simulates the queries 152 using known techniques to determine the respective workload costs 315. The workload cost 315 is reflective of how the system 100 would perform when executing queries 152 with the respective index 212 stored in the database 150. A lower workload cost 315 generally indicates that having the respective index 212 in the database 150 would result in a consumption of fewer resources and/or a faster execution time when executing the plurality of queries 152.

Optionally, the optimizer 310, after determining the workload costs 315 selects the candidate index 212C with the lowest workload cost 315. In the example of FIG. 3, at the first iteration 301 the optimizer 310 selects the index 212a for the recommended index configuration 162. Before proceeding to the next iteration 302, the optimizer 310 determines whether the recommended index configuration 162 satisfies any thresholds 312. Here, the recommended index configuration 162 does not satisfy any thresholds 312, and thus the iterative process 300 moves on to perform a second iteration 302. For the second iteration 302, the optimizer 310 again determines a workload cost 315 for each candidate index 212C in the set of candidate indexes 212C. However, at the second iteration 302, the optimizer 310 determines the respective workload cost 315 for each candidate index 212 and the first index 212a already selected for the recommended index configuration 162 based on the queries 152. In other words, the optimizer 310 determines a new workload cost 315 indicating how the system 100 would perform when executing queries 152 with both the respective index 212 stored in the database 150 along with each of the other indexes 212 in the recommended index configuration 162 (i.e., the first index 212a in this example). The optimizer 310, for example, selects the candidate index 212C from the set of candidate indexes 212C with the lowest respective workload cost 315 for the recommended index configuration 162. In this example, the optimizer selects a second index 212d and the recommend index configuration 162 now includes two indexes 212a, 212d. The optimizer 310 then determines if the recommended index configuration 162 satisfies the threshold 312.

The iterative process 300 repeats until the recommended index configuration 162 satisfies one or more of the thresholds 312. In the example of FIG. 3, the final iteration 303 adds an index 212, 212n as the last index 212 to the recommended index configuration 162. After adding the index 212n to the recommended index configuration 162, the optimizer 310 determines that the recommended index configuration 162 satisfies at least one of the thresholds 312. As described above, the threshold 312 may indicate a maximum memory size for recommended index configuration 162, a maximum total number of indexes 212 for the recommended index configuration 162, a minimum improvement for the workload cost 315, etc. In some implementations, the recommended index configuration 162 satisfies the threshold 312 when the recommended index configuration 162 exceeds the threshold 312. For example, when the recommended index configuration 162 is 300 MB and the threshold 312 indicates that the maximum memory size for the recommended index configuration 162 is 200 MB, then the recommended index configuration 162 satisfies the threshold 312. Optionally, the optimizer 310 may eliminate the most recently added index 212 from the recommended index configuration 162 to reduce the size of the recommended index configuration 162 below the threshold 312. In the example of FIG. 3, the optimizer 310 removes index 212n from the recommended index configuration 162.

In some examples, the optimizer 310, after determining that the recommended index configuration 162 is complete, transmits the recommended index configuration 162 to a user 12. The user 12 may determine whether to implement the index reconfiguration as recommended. The user 12 may alter the recommendation by deleting or adding indexes 212. In some examples, the index advisor module 180 automatically (i.e., without user intervention) stores one or more of the indexes 212 of the recommended index configuration 162. The index advisor module 180 may replace an existing index configuration (i.e., replace any currently stored indexes 212 with the indexes 212 of the recommended index configuration 162) or supplement an existing index configuration 162 (i.e., add the indexes 212 of the recommended index configuration 162 to the database 150 with any previously stored indexes 212). In some examples, the optimizer 310 begins the iterative process with the recommend index configuration 162 already including any previously stored indexes 212 such that the optimizer 310 only adds indexes 212 to the currently stored indexes 212. In other examples, the optimizer 310 recommends removing one or more previously stored indexes based on the plurality of queries 152 (e.g., when a stored index 212 is rarely used). Further, the index advisor module 180 may monitor incoming queries 152 in real-time and rewrite queries 152 based on the recommended index configuration 162 such that the query 152 can be executed using indexes 212 stored in the database 150. In other implementations, the index advisor module 180 tracks workloads of the system 100 at a system wide and/or cluster level.

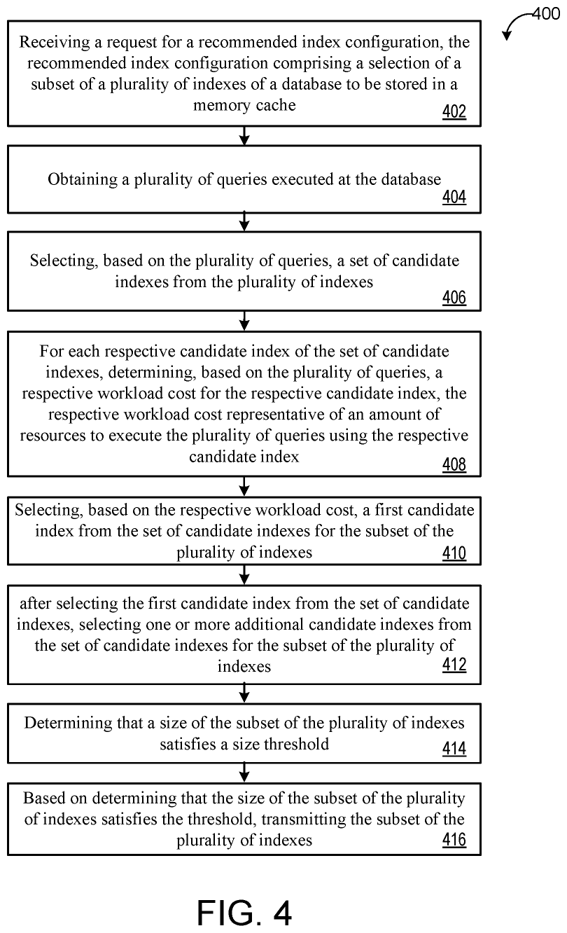

FIG. 4 is a flowchart of an exemplary arrangement of operations for a method 400 for workload-driven index selection. The method 400 may be performed, for example, by various elements of the index recommendation system 100 of FIG. 1. At operation 402, the method 400 includes receiving a request 20 for a recommended index configuration 162, the recommended index configuration 162 including a selection of a subset of a plurality of indexes 212 of a database 150 to be stored in a memory of the database 150. At operation 404, the method 400 includes obtaining a plurality of queries 152 executed at the database 150. Further, at operation 406, the method 400 includes selecting, based on the plurality of queries 152, a set of candidate indexes 212, 212C from the plurality of indexes 212. At operation 408, the method 400 includes for each respective candidate index 212C of the set of candidate indexes 212, determining, based on the plurality of queries 152, a respective workload cost 315 for the respective candidate index 212C, the respective workload cost 315 representative of an amount of resources to execute the plurality of queries 152 using the respective candidate index 212C. Further, at operation 410, the method 400 includes selecting, based on the respective workload cost 315, a first candidate index 212 from the set of candidate indexes 212 for the recommended index configuration 162. At operation 412, the method 400 includes, based on selection of the first candidate index 212C from the set of candidate indexes 212C, selecting one or more additional candidate indexes 212C from the set of candidate indexes 212C for the recommended index configuration 162. At operation 414, the method 400 includes determining that a size of the recommended index configuration 162 satisfies a size threshold 312. At operation 416, the method 400 includes based on determining that the size of the recommended index configuration 162 satisfies the threshold, transmitting the recommended index configuration 162.

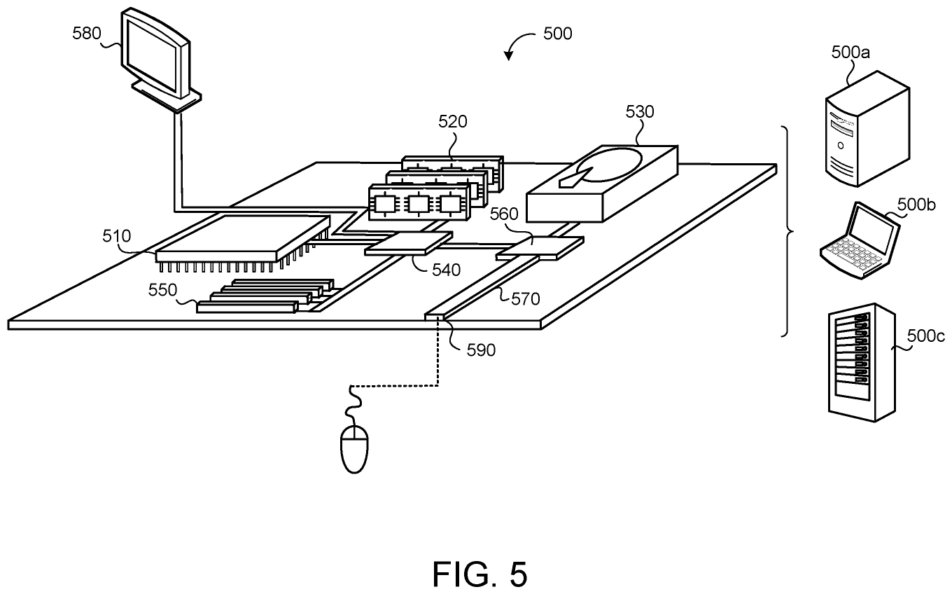

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed by data processing hardware that causes the data processing hardware to perform operations comprising:
receiving a request for a recommended index configuration from a user device, the recommended index configuration comprising a selection of a subset of a plurality of indexes of a database, the subset of the plurality of indexes to be stored in a memory of the database;
obtaining a plurality of historical queries previously executed at the database;
selecting, based on the plurality of historical queries, a set of candidate indexes from the plurality of indexes;
for each respective candidate index of the set of candidate indexes, determining, based on the plurality of historical queries, a respective workload cost for the respective candidate index, the respective workload cost representative of an amount of resources to execute the plurality of historical queries using the respective candidate index;
selecting, based on the respective workload cost, a first candidate index from the set of candidate indexes for the recommended index configuration;
based on selection of the first candidate index, selecting one or more additional candidate indexes from the set of candidate indexes for the recommended index configuration;
determining that a size of the recommended index configuration satisfies a size threshold;
based on determining that the size of the recommended index configuration satisfies the size threshold, transmitting the recommended index configuration from the user device;
receiving a plurality of queries to be executed at the database from the user device, the received plurality of queries different from the plurality of historical queries;
executing, based on the recommended index configuration, the received plurality of queries at the database; and
transmitting one or more results of executing the received plurality of queries at the database to the user device.

2. The method of claim 1, wherein each candidate index of the set of candidate indexes is a single column index.

3. The method of claim 1, wherein the plurality of queries is associated with a query hash.

4. The method of claim 1, wherein selecting the one or more additional candidate indexes from the set of candidate indexes comprises:
for each respective candidate index of the set of candidate indexes not in the recommended index configuration, determining, based on the plurality of queries, a second respective workload cost for the respective candidate index, the second respective workload cost representative of an amount of resources to execute the plurality of queries using the respective candidate index and each index in the recommended index configuration; and
selecting, based on the second respective workload cost, a second candidate index from the set of candidate indexes for the subset of the plurality of indexes.

5. The method of claim 1, wherein the operations further comprise selecting one or more additional candidate indexes for the recommended index configuration until the recommended index configuration satisfies an improvement threshold.

6. The method of claim 1, wherein the database comprises a cloud database.

7. The method of claim 1, wherein the respective workload cost is based on query stats of the plurality of queries.

8. The method of claim 7, wherein the query stats comprise at least one of:
a type of query;
an extrusion time;
a number of calls; or an order of queries.

9. The method of claim 1, wherein the operations further comprise:
obtaining a new plurality of queries; and
selecting, based on the new plurality of queries, a new recommended index configuration.

10. The method of claim 1, wherein a number of candidate indexes in the set of candidate indexes is configurable by a user.

11. A system comprising:
data processing hardware; and
memory hardware in communication with the data processing hardware, the memory hardware storing instructions that, when executed on the data processing hardware, cause the data processing hardware to perform operations comprising:
receiving a request for a recommended index configuration from a user device, the recommended index configuration comprising a selection of a subset of a plurality of indexes of a database, the subset of the plurality of indexes to be stored in a memory of the database;
obtaining a plurality of historical queries previously executed at the database;
selecting, based on the plurality of historical queries, a set of candidate indexes from the plurality of indexes;
for each respective candidate index of the set of candidate indexes, determining, based on the plurality of historical queries, a respective workload cost for the respective candidate index, the respective workload cost representative of an amount of resources to execute the plurality of historical queries using the respective candidate index;
selecting, based on the respective workload cost, a first candidate index from the set of candidate indexes for the recommended index configuration;
based on selection of the first candidate index, selecting one or more additional candidate indexes from the set of candidate indexes for the recommended index configuration;
determining that a size of the recommended index configuration satisfies a size threshold;
based on determining that the size of the recommended index configuration satisfies the size threshold, transmitting the recommended index configuration from the user device;
receiving a plurality of queries to be executed at the database from the user device, the received plurality of queries different from the plurality of historical queries;
executing, based on the recommended index configuration, the received plurality of queries at the database; and
transmitting one or more results of executing the received plurality of queries at the database to the user device.

12. The system of claim 11, wherein each candidate index of the set of candidate indexes comprises a single column index.

13. The system of claim 11, wherein the plurality of queries is associated with a query hash.

14. The system of claim 11, wherein selecting the one or more additional candidate indexes from the set of candidate indexes comprises:
for each respective candidate index of the set of candidate indexes not in the recommended index configuration, determining, based on the plurality of queries, a second respective workload cost for the respective candidate index, the second respective workload cost representative of an amount of resources to execute the plurality of queries using the respective candidate index and each index in the recommended index configuration; and
selecting, based on the second respective workload cost, a second candidate index from the set of candidate indexes for the subset of the plurality of indexes.

15. The system of claim 11, wherein the operations further comprise selecting one or more additional candidate indexes for the recommended index configuration until the recommended index configuration satisfies an improvement threshold.

16. The system of claim 11, wherein the database is a cloud database.

17. The system of claim 11, wherein the respective workload cost is based on query stats of the plurality of queries.

18. The system of claim 17, wherein the query stats comprise at least one of:
a type of query;
an extrusion time;
a number of calls; or
an order of queries.

19. The system of claim 11, wherein the operations further comprise:
obtaining a new plurality of queries; and
selecting, based on the new plurality of queries, a new recommended index configuration.

20. The system of claim 11, wherein a number of candidate indexes in the set of candidate indexes is configurable by a user.
